(19) United States
(12) Patent Application Publication
(10) Pub. No.: US 2026/0263300 A1
(43) Pub. Date: Sep. 10, 2026

(54) CARRIER DEVICE

(71) Applicant: JTEKT MACHINE SYSTEMS CORPORATION, Yao-shi, Osaka (JP)

(72) Inventor: Hiroyuki NIWA, Yao-shi, Osaka, Japan (JP)

(73) Assignee: JTEKT MACHINE SYSTEMS CORPORATION, Yao-shi, Osaka (JP)

(21) Appl. No.: 19/167,432

(22) PCT Filed: Mar. 4, 2024
(86) PCT No.: PCT/JP2024/008150

§ 371 Date: Sep. 22, 2025

(30) Foreign Application Priority Data
Mar. 22, 2023 (JP) 2023-045891

(51) Int. Cl. A61G 7/05; B60B 19/00; B62D 11/04

(52) U.S. Cl. CPC A61G 7/0528; A61G 7/0506; B60B 19/003; B62D 11/04

(57) ABSTRACT

A transport apparatus is attached to a bed having casters and one end in a lengthwise direction supported by an operator. The transport apparatus includes first and second mecanum wheels, first and second motors respectively connected to the first and second mecanum wheels, an operation unit that receives an input of a moving direction, and a controller. When a lateral moving direction is inputted to the operation unit, the controller operates the first and second mecanum wheels to move the bed in the inputted lateral moving direction while turning the bed about a rotation center located at the one end.

### TECHNICAL FIELD

The present disclosure relates to a transport apparatus.

### BACKGROUND ART

For example, Patent Document 1 discloses an auxiliary propulsion system using mecanum wheels in a drive unit. The auxiliary propulsion system includes a pair of mecanum wheels connected to a chassis, motors that respectively drive the mecanum wheels, and a control system that senses changes in the rotational speed of each motor. The chassis to which the mecanum wheels are connected has front wheels and rear wheels, and is configured to receive a force applied from the rear side by an operator moving the chassis.

According to Patent Document 1 described above, when moving the chassis laterally in a predetermined direction, the operator applies a force in the same direction. As each mecanum wheel is rotated by the applied force, an associated change in rotational speed is reported to the control system. The control system starts electric rotation of the motors based on the report. The electric rotation assists the lateral movement of the chassis.

### CITATION LIST

### Patent Document

Patent Document 1: Japanese Unexamined Patent Publication No. 2016-525977

### SUMMARY OF THE INVENTION

### Technical Problem

If two mecanum wheels are used as in Patent Document 1, the mecanum wheels rotate in the same direction when the chassis moves in the lateral direction in which the mecanum wheels are arranged and when the chassis turns about the center position between the mecanum wheels. In this case, when the mecanum wheels rotate to assist the lateral movement of the chassis, the lateral movement and the turning motion occur at the same time.

Thus, if the configuration of Patent Document 1 is adopted and a rightward force is applied from the rear wheel side of the chassis, for example, a rear wheel portion of the chassis laterally moves to the right, but a front wheel portion of the chassis turns to the left because the turning motion occurs simultaneously with the lateral movement. In this case, the front wheel portion needs to be moved in the opposite direction by hand, which is inconvenient for making the lateral movement smoothly.

Further, if the operator tries to move the chassis laterally away from a wall in a narrow space, such as the inside of an elevator, the front wheel portion turns in the opposite direction as described above and may possibly hit the wall surface.

The present disclosure has been made in view of the above circumstances, and an object thereof is to allow a transport apparatus with two mecanum wheels to achieve a smooth lateral movement.

### Solution to the Problem

A first aspect of the present disclosure is directed to a transport apparatus that is attached to a bed with casters and is configured to move the bed laterally, one end of the bed in a lengthwise direction being supported by an operator. The transport apparatus includes: a first mecanum wheel and a second mecanum wheel that are attached to a lower portion of the bed; a first motor and a second motor that are respectively connected to the first mecanum wheel and the second mecanum wheel to drive the first mecanum wheel and the second mecanum wheel; an operation unit that receives an input of a moving direction of the bed; and a controller that controls the first and second motors. When a lateral moving direction is inputted to the operation unit, the controller operates the first and second mecanum wheels via the first and second motors to move the bed in the lateral moving direction inputted to the operation unit while turning the bed about a rotation center located at the one end.

According to the first aspect, the one end of the bed has the smaller amount of movement (in particular, the amount of movement in the inputted moving direction) during the turning motion than the other end because the one end is closer to the rotation center than the other end. However, the operator supporting the one end of the bed also moves laterally along with the lateral movement of the bed, ensuring the amount of movement of the one end. This allows both the one end and the other end of the bed to move sufficiently, allowing the entire bed to laterally move in a desired moving direction. This can achieve a smooth lateral movement of the bed although the transport apparatus uses two mecanum wheels.

A second aspect of the present disclosure is directed to a transport apparatus that is attached to a bed with casters and is configured to move the bed laterally. The transport apparatus includes: a first mecanum wheel and a second mecanum wheel that are attached to a lower portion of the bed; a first motor and a second motor that are respectively connected to the first mecanum wheel and the second mecanum wheel to drive the first mecanum wheel and the second mecanum wheel; an operation unit that is configured to be supported on one end of the bed in a lengthwise direction and receives an input of a moving direction of the bed; and a controller that controls the first and second motors. When the moving direction is inputted to the operation unit, the controller operates the first and second mecanum wheels via the first and second motors to laterally move the bed in the moving direction inputted to the operation unit while turning the bed about a rotation center located at the one end.

According to the second aspect, the operation unit is supported on the one end of the bed. Thus, the operator unconsciously supports the one end of the bed when operating the operation unit without thinking of the one end of the bed. This ensures the amount of movement of the one end by prompting the operator to move laterally as in the first aspect. This allows both the one end and the other end of the bed to move sufficiently, allowing the entire bed to laterally move in a desired moving direction. This can achieve a smooth lateral movement of the bed although the transport apparatus uses two mecanum wheels.

According to a third aspect of the present disclosure, the first and second mecanum wheels are arranged side by side in a widthwise direction of the bed, each of the first and second mecanum wheels may include a wheel body that rotates about a rotation axis extending in the widthwise direction and a plurality of barrel-shaped rollers arranged along an outer periphery of the wheel body and rotating about an inclined axis inclined with respect to both the widthwise direction and the lengthwise direction, and the inclined axis of the first mecanum wheel is inclined with respect to the inclined axis of the second mecanum wheel to be line-symmetrical with respect to the lengthwise direction.

According to the third aspect, the first mecanum wheel and the second mecanum wheel rotate in opposite directions to simultaneously generate a thrust for turning the bed and a thrust for laterally moving the bed. The former thrust contributes to the generation of the turning motion about the rotation center located at the one end of the bed, and the latter thrust suitably acts to prompt the operator to move laterally. Thus, the configuration of the third aspect is effective in making a smooth lateral movement using the two mecanum wheels.

According to a fourth aspect of the present disclosure, when the moving direction is inputted to the operation unit, the controller commands rotational speeds of the first and second mecanum wheels so that one of the first and second mecanum wheels rotates forward and the other rotates rearward, and when commanding the rotational speeds, makes absolute values of the commanded rotational speeds of the first and second mecanum wheels equal to each other.

According to the fourth aspect, a lateral movement parallel to the lateral direction can be achieved by making the absolute values of the commanded rotational speeds of the first mecanum wheel and the second mecanum wheel equal to each other. This is effective in making a smooth lateral movement using the two mecanum wheels.

According to a fifth aspect of the present disclosure, a head plate of the bed may be arranged at the one end, and a foot plate of the bed may be arranged at the other end opposite to the one end in the lengthwise direction.

For the conveyance of a medical bed, for example, the head plate is usually supported by the operator. Thus, arranging the head plate at the one end where the rotation center is located during the turning motion allows the operator to naturally support the one end without providing any special markers or indications. This is effective in making a smooth lateral movement using the two mecanum wheels.

### Advantages of the Invention

As described above, the present disclosure allows the transport apparatus with the two mecanum wheels to achieve a smooth lateral movement of the bed.

### BRIEF DESCRIPTION OF THE DRAWINGS

FIG. 1 is a side view illustrating a general configuration of a transport apparatus and a bed with casters.

FIG. 2 is a bottom view illustrating the general configuration of the transport apparatus and the bed with casters.

FIG. 3 is a perspective view illustrating a configuration of the transport apparatus.

FIG. 4 is a plan view illustrating the configuration of the transport apparatus.

FIG. 5 is a side view illustrating the configuration of the transport apparatus.

FIG. 6 is a block diagram illustrating a configuration of a control system of the transport apparatus.

FIG. 7 is a front view illustrating a configuration of an operation unit.

FIG. 8 is a view illustrating how first and second mecanum wheels move.

FIG. 9A is a view illustrating a specific example of a lateral movement using the transport apparatus.

FIG. 9B is a view illustrating the specific example of the lateral movement using the transport apparatus.

FIG. 9C is a view illustrating the specific example of the lateral movement using the transport apparatus.

FIG. 10 is a flowchart of a process related to the lateral movement of the bed.

FIG. 11 is a view illustrating commanded rotational speeds of motors during the lateral movement.

FIG. 12 is a view illustrating a conventional example of the transport apparatus.

FIG. 13 is a view illustrating a variation of the transport apparatus.

### DESCRIPTION OF EMBODIMENT

An embodiment of the present disclosure will be described below with reference to the drawings.

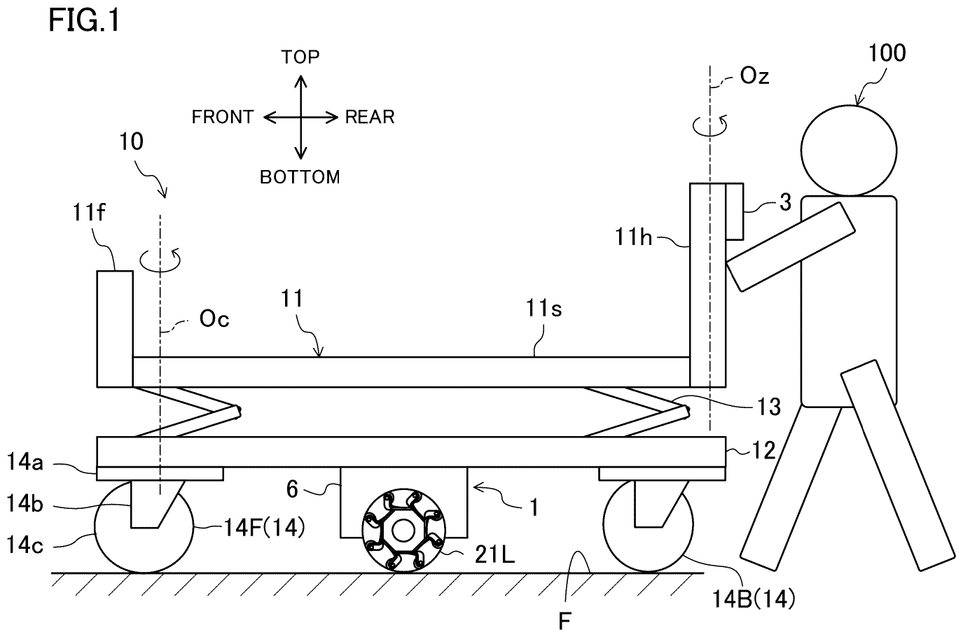

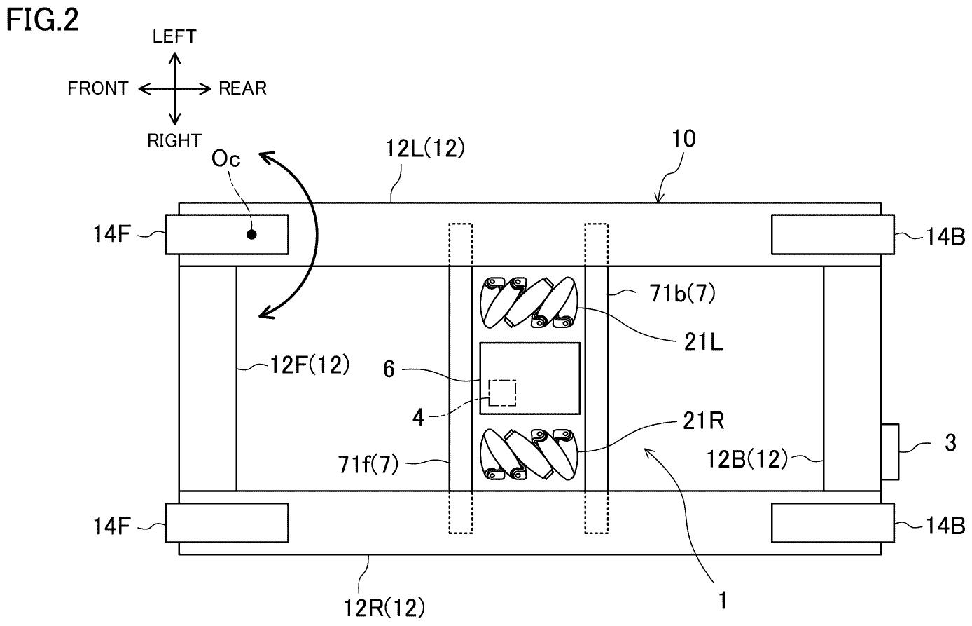

FIG. 1 is a side view illustrating a general configuration of a transport apparatus 1 and a caster bed 10, and FIG. 2 is a bottom view illustrating the general configuration of the transport apparatus 1 and the caster bed 10.

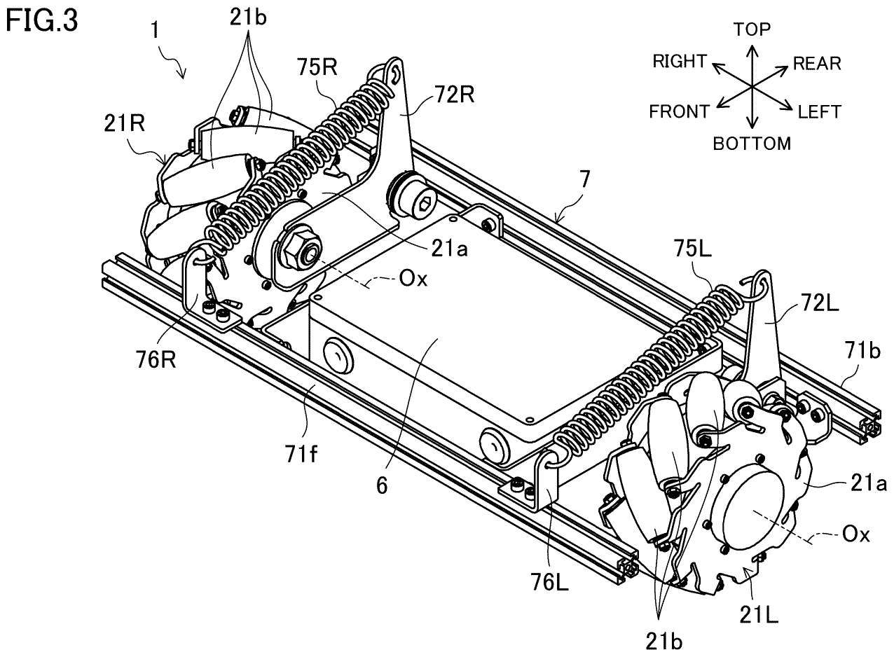

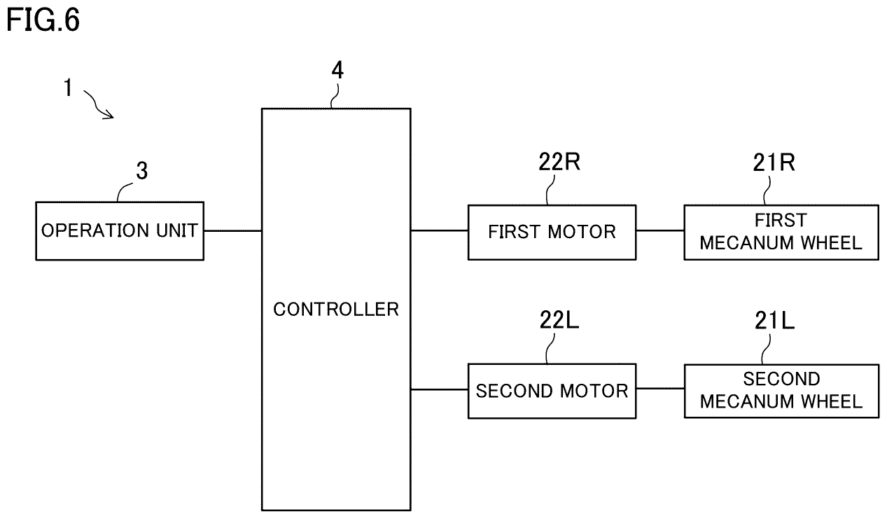

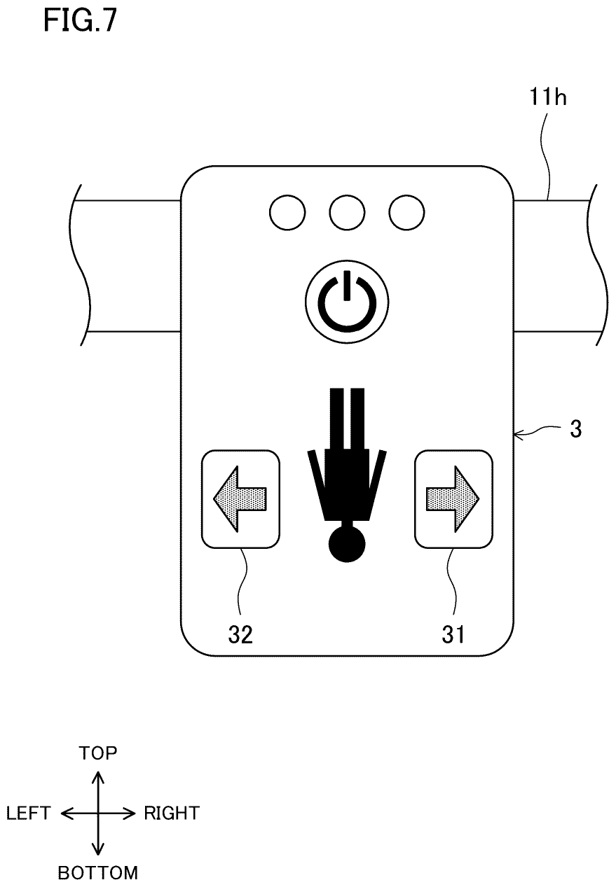

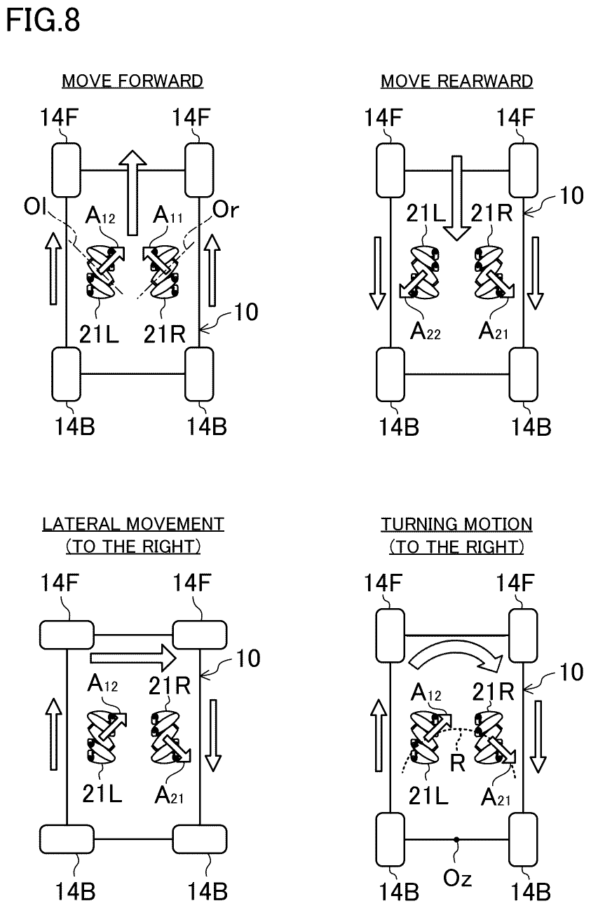

FIGS. 3, 4 and 5 are perspective, plan, and side views each illustrating the configuration of the transport apparatus 1. FIG. 6 is a block diagram illustrating the configuration of a control system of the transport apparatus 1, FIG. 7 is a front view illustrating the configuration of an operation unit 3, and FIG. 8 is a view illustrating how first and second mecanum wheels 21R and 21L move.

As shown in FIGS. 1 and 2, the transport apparatus 1 according to the present embodiment is attached to a bed 10 with casters (hereinafter simply referred to as a “bed”). The bed 10 includes a plurality of casters 14 including front casters 14F and rear casters 14B, and is used as a medical bed, for example.

Hereinafter, a lengthwise direction of the bed 10, that is, a direction in which a person lies on the bed 10 is referred to as a “front-rear direction” or a “longitudinal direction,” one side in the front-rear direction toward the toes of the person is referred to as the “front,” and the other side toward the head of the person is referred to as the “rear.” Similarly, a widthwise direction of the bed 10, that is, a direction orthogonal to the front-rear direction on a horizontal plane is defined as a “left-right direction” or a “lateral direction,” one side in the left-right direction toward the back of the paper of FIG. 1 is defined as the “right,” and the other side toward the front of the paper of FIG. 1 is defined as the “left” (see FIG. 2 for details). The “left-right direction” referred to herein means the left-right direction when the bed is viewed from the back side toward the front side. In the following description, a “lateral movement” refers to a movement in the left-right direction. The left-right direction (lateral direction) can also be defined as a direction that is orthogonal to the front-rear direction and extends along a transport surface F (a floor surface on which the bed 10 travels).

One end of the bed 10 in the front-rear direction (e.g., a rear end) is supported by an operator 100. The transport apparatus 1 is configured to laterally move the bed 10 supported by the operator 100.

As shown in FIG. 1, the bed 10 includes a bed body 11 on which a mattress (not shown) is placed, a frame 12 that supports the bed body 11 from below, a lifter 13 that raises and lowers the bed body 11 with respect to the frame 12, and a plurality of casters 14 (four casters in the illustrated example) arranged on the bottom of the bed 10. When used as a medical bed, the bed 10 weighs, for example, 60 kg or more and 300 kg or less.

The bed body 11 includes a headboard 11h arranged at a rear end of the bed 10, a footboard 11f arranged at a front end opposite to the rear end in the front-rear direction, and side rails 11s arranged on the left and right sides of the bed 10.

The headboard 11h is supported from the rear side by the operator 100 to move the bed 10 by hand. The headboard 11h serves as a support to which a force is applied by the operator 100. A member such as a handle or a grip may be attached to or integrated with the headboard 11h so that the member is used as the support.

As shown in FIG. 2, the frame 12 is formed in a rectangular frame shape, and includes four sides consisting of a front frame 12F, a right frame 12R, a left frame 12L, and a rear frame 12B.

The front frame 12F is arranged on the front side of the bed 10 and extends in the left-right direction. The right frame 12R is arranged on the right side of the bed 10 and extends in the front-rear direction. The left frame 12L is arranged on the left side of the bed 10 and extends in the front-rear direction. The rear frame 12B is arranged on the rear side of the bed 10 and extends in the left-right direction.

As shown in FIGS. 1 and 2, the front casters 14F and the rear casters 14B constituting the casters 14 are arranged at four corners of the bottom of the bed 10. Two front casters 14F are arranged in the left-right direction, and two rear casters 14B are also arranged in the left-right direction. The casters 14 support the frame 12, the lifter 13, and the bed body 11 with respect to the transport surface F.

Each caster 14 is a so-called free caster, and includes a mount 14a fixed to the bottom of the bed 10, a fork 14b that can swivel about a swivel axis Oc relative to the mount 14a, and a wheel 14c rotatably supported by the fork 14b. The swivel axis Oc of each fork 14b extends vertically (along the height of the bed 10). A rotation axis of each wheel 14c extends along a horizontal plane. The rotation axis is inclined with respect to the left-right direction when the fork 14b swivels relative to the mount 14a.

The transport apparatus 1 is arranged to span a middle portion of the right frame 12R in the front-rear direction and a middle portion of the left frame L in the front-rear direction. The transport apparatus 1 is arranged between the front casters 14F and the rear casters 14B in the front-rear direction and at the center of the bed 10 in the left-right direction.

As shown in FIGS. 1 to 6, the transport apparatus 1 includes a housing box 6, a fixture 7, first and second mecanum wheels 21R and 21L, first and second motors 22R and 22L, an operation unit 3, and a controller 4 (the first and second motors 22R and 22L are shown only in FIG. 6). It is assumed that, of the first and second mecanum wheels 21R and 21L, the first mecanum wheel 21R is located on the right, and the second mecanum wheel 21L is located on the left.

Among these components, the controller 4 is contained in the housing box 6, and the fixture 7, the first and second mecanum wheels 21R and 21L, the first and second motors 22R and 22L, and the operation unit 3 are arranged outside the housing box 6.

The housing box 6 contains the controller 4 as described above. The housing box 6 is arranged between the first mecanum wheel 21R and the second mecanum wheel 21L in the left-right direction.

The housing box 6 is assembled to the fixture 7 together with the first and second mecanum wheels 21R and 21L, and is attached to the lower portion of the bed 10 with the fixture 7. The fixture 7 is detachably attached to the lower portion of the bed 10. That is, the transport apparatus 1 of the present embodiment can be retrofitted to the bed 10 and can be removed as necessary.

Specifically, as shown in FIGS. 2 to 5, the fixture 7 of the present embodiment includes a front rail member 71f, a rear rail member 71b, a first arm member 72R that rotatably supports the first mecanum wheel 21R, and a second arm member 72L that rotatably supports the second mecanum wheel 21L.

The front rail member 71f and the rear rail member 71b are spaced in the front-rear direction, and each of the front rail member 71f and the rear rail member 71b spans a central portion of the right frame 12R in the front-rear direction and a central portion of the left frame 12L in the front-rear direction. The front rail member 71f and the rear rail member 71b are detachably attached to the right frame 12R and the left frame 12L. The first and second mecanum wheels 21R and 21L and the housing box 6 are arranged between the front rail member 71f and the rear rail member 71b in the front-rear direction.

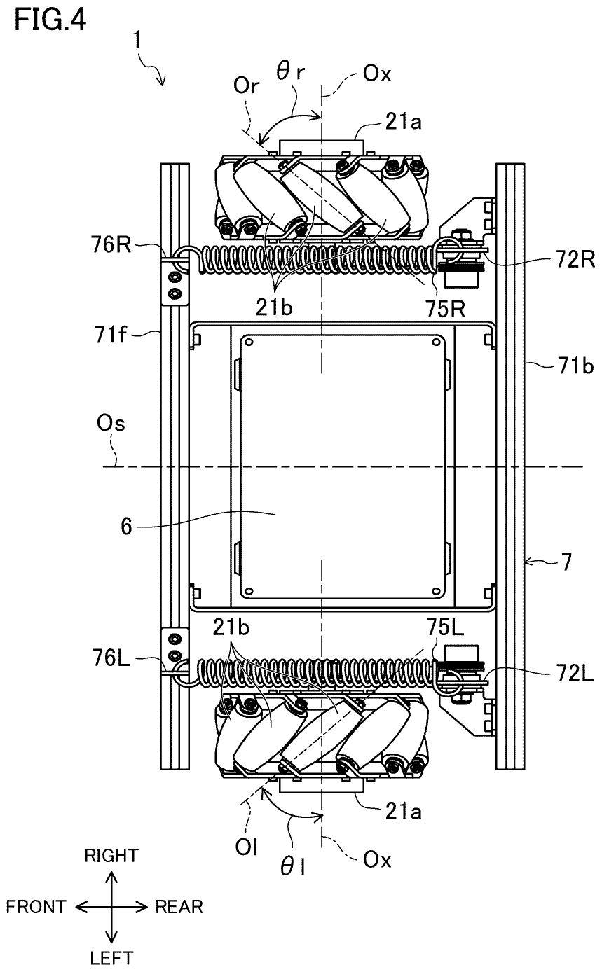

The first arm member 72R on the right side in FIGS. 3 and 4 is swingably supported by the rear rail member 71b. A front end portion of the first arm member 72R rotatably supports the first mecanum wheel 21R. The first arm member 72R is arranged between the first mecanum wheel 21R and the housing box 6 in the left-right direction.

One end of a first tension spring 75R is locked to an upper end portion of the first arm member 72R. The other end of the first tension spring 75R is locked to a first bracket 76R fixed to the front rail member 71f.

The second arm member 72L on the left side in FIGS. 3 and 4 is swingably supported by the rear rail member 71b, similarly to the first arm member 72R. A front end portion of the second arm member 72L rotatably supports the second mecanum wheel 21L. The second arm member 72L is arranged between the second mecanum wheel 21L and the housing box 6 in the left-right direction.

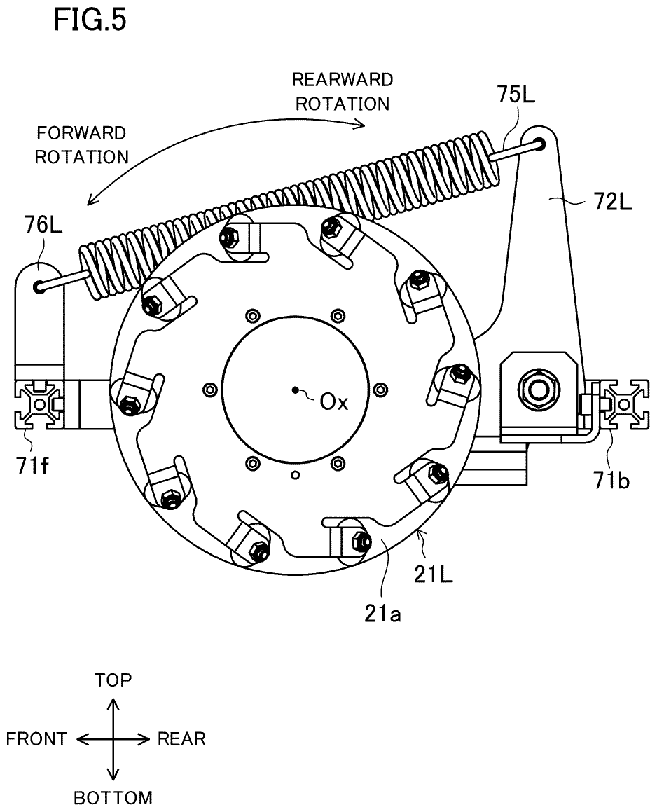

One end of a second tension spring 75L is locked to an upper end portion of the second arm member 72L. The other end of the second tension spring 75L is locked to a second bracket 76L fixed to the front rail member 71f (see also FIG. 5).

As shown in FIGS. 1 and 2, the first and second mecanum wheels 21R and 21L are attached to a lower portion (bottom) of the bed 10. The first and second mecanum wheels 21R and 21L are arranged behind the front casters 14F and in front of the rear casters 14B. The first and second mecanum wheels 21R and 21L are arranged side by side in the left-right direction which is the widthwise direction, as shown in FIG. 2.

Specifically, as shown in FIGS. 3 to 5, the first mecanum wheel 21R includes a wheel body 21a that rotates about a rotation axis Ox extending in the left-right direction and a plurality of barrel-shaped rollers 21b that are arranged along an outer periphery of the wheel body 21a and rotate about an inclined axis Or inclined with respect to both the left-right direction and the front-rear direction. The second mecanum wheel 21L includes a wheel body 21a that rotates about a rotation axis Ox extending in the left-right direction and a plurality of barrel-shaped rollers 21b that are arranged along an outer periphery of the wheel body 21a and rotate about an inclined axis Ol inclined with respect to both the left-right direction and the front-rear direction.

As shown in FIG. 4, the inclined axis Or of the barrel-shaped rollers 21b constituting the first mecanum wheel 21R (hereinafter also referred to as a “first inclined axis”) is inclined to be line-symmetrical with the inclined axis Ol of the barrel-shaped rollers 21b constituting the second mecanum wheel 21L (hereinafter also referred to as a “second inclined axis”) with respect to the front-rear direction (see a symmetry axis Os in FIG. 4). In other words, the first inclined axis Or and the second inclined axis Ol extend to be mirror-symmetrical when viewed in plan.

When viewed from above as shown in FIG. 4 (when viewed in plan), the inclined axes Or and Ol of the barrel-shaped rollers 21b, 21b extend from the inside to the outside in the left-right direction (from the center portion in the left-right direction to the right or the left) as they extend from the rear side to the front side in the front-rear direction.

Specifically, the first inclined axis Or extends from the center portion to the right in the left-right direction as it extends from the rear side to the front side in the front-rear direction. The second inclined axis Ol extends from the center portion to the left in the left-right direction as it extends from the rear side to the front side in the front-rear direction.

More specifically, an inclination angle θr of the first inclined axis Or with respect to the rotation axis Ox is 45° in plan view. Similarly, an inclination angle θl of the second inclined axis Ol with respect to the rotation axis Ox is also 45° in plan view. The direction and angle of inclination of each of the barrel-shaped rollers 21b are not limited to these examples.

As described above, the first and second mecanum wheels 21R and 21L are mutually connected via the front rail member 71f and the rear rail member 71b shown in FIG. 3 and some other drawings. Thus, the first and second mecanum wheels 21R and 21L integrally move in the front-rear direction and the left-right direction and integrally turn around a turning axis perpendicular to a horizontal plane.

The first and second motors 22R and 22L are respectively connected to the first and second mecanum wheels 21R and 21L to drive the first and second mecanum wheels 21R and 21L. In particular, each of the first and second motors 22R and 22L is configured as a DC brushless motor equipped with an encoder. Both the first and second motors 22R and 22L are electrically connected to the controller 4, and are operated when receiving a signal from the controller 4.

The first motor 22R is connected to the first mecanum wheel 21R to be able to transmit a driving force (torque) to the first mecanum wheel 21R. The second motor 22L is connected to the second mecanum wheel 21L to be able to transmit a driving force (torque) to the second mecanum wheel 21L.

The first motor 22R is incorporated in the first mecanum wheel 21R, and the second motor 22L is incorporated in the second mecanum wheel 21L. Incorporating the first and second motors 22R and 22L in this manner makes the entire transport apparatus 1 simple and compact.

The operation unit 3 is configured to receive an input of a moving direction of the bed 10. The operation unit 3 is a remote controller that receives the input of the moving direction, and is connected to the controller 4 by wire or wirelessly. The moving direction that can be received by the operation unit 3 includes at least the left-right direction (in particular, both the right direction and the left direction).

Specifically, as shown in FIG. 7, the operation unit 3 according to the present embodiment includes a right switch 31 that is pressed when instructing a lateral movement to the right, and a left switch 32 that is pressed when instructing a lateral movement to the left. When the right switch 31 is pressed, the operation unit 3 generates an electrical signal corresponding to the pressing, and when the left switch 32 is pressed, the operation unit 3 generates another electrical signal corresponding to the pressing. The operation unit 3 inputs the generated electrical signals to the controller 4.

The operation unit 3 according to the present embodiment is configured to be supported on one end of the bed 10 in the front-rear direction. For example, the operation unit 3 shown in FIG. 1 is attached to the headboard 11h at the rear end of the bed 10 (see also FIG. 7). The operation unit 3 may be separated from or integrated with a component functioning as the above-described support, such as the headboard 11h. In the former case, the operation unit 3 may be configured to be locked to the headboard 11h.

The controller 4 controls the first and second motors 22R and 22L based on the electrical signal inputted from the operation unit 3. The controller 4 includes a CPU, memory, and an input/output bus, and is constituted of, for example, a control board.

The controller 4 commands the rotational speed of each of the first and second motors 22R and 22L based on the electrical signals inputted from the operation unit 3, and inputs control signals corresponding to the commanded rotational speeds to the first and second motors 22R and 22L. The first and second motors 22R and 22L rotate at the rotational speeds commanded by the controller 4. By changing the signs of the commanded rotational speeds, the directions of rotation of the first motor 22R and the second motor 22L can be individually changed.

When the first motor 22R rotates, the driving force is transmitted to rotate the first mecanum wheel 21R. Similarly, when the second motor 22L rotates, the driving force is transmitted to rotate the second mecanum wheel 21L. At this time, by changing the rotation directions of the motors 22R and 22L as described above, the corresponding mecanum wheels 21R and 21L can be switched between forward rotation and rearward rotation.

In the present embodiment, when the first mecanum wheel 21R located on the right rotates forward, a thrust can be exerted on the transport apparatus 1 and the bed 10 obliquely forward to the left (see an arrow An in FIG. 8). When the second mecanum wheel 21L located on the left rotates forward, the transport apparatus 1 can exert a thrust to the bed 10 diagonally forward to the right (see an arrow A12 in FIG. 8).

Thus, as shown in an upper left part of FIG. 8, for example, when both the first and second mecanum wheels 21R and 21L rotate forward, the thrust to the left exerted by the forward rotation of the first mecanum wheel 21R and the thrust to the right exerted by the forward rotation of the second mecanum wheel 21L cancel each other out, allowing the entire transport apparatus 1 to generate a thrust to the front. This thrust moves the bed 10 forward.

Similarly, when the first mecanum wheel 21R located on the right rotates rearward, a thrust can be exerted on the transport apparatus 1 and the bed 10 obliquely rearward to the right (see an arrow A21 in FIG. 8). When the second mecanum wheel 21L located on the left rotates rearward, the transport apparatus 1 can exert a thrust to the bed 10 obliquely rearward to the left (see an arrow A22 in FIG. 8).

Thus, as shown in an upper right part of FIG. 8, for example, when both the first and second mecanum wheels 21R and 21L rotate rearward, the thrust to the right exerted by the rearward rotation of the first mecanum wheel 21R and the thrust to the left exerted by the rearward rotation of the second mecanum wheel 21L cancel each other out, allowing the entire transport apparatus 1 to generate a thrust to the rear. This thrust moves the bed 10 rearward.

When one of the first and second mecanum wheels 21R and 21L rotates forward and the other rotates rearward, the transport apparatus 1 can exert a thrust to the bed 10 in the left-right direction.

In an example shown in a lower left part of FIG. 8, the first mecanum wheel 21R rotates rearward and the second mecanum wheel 21L rotates forward, applying a thrust to the right to the bed 10.

However, when one of the first and second mecanum wheels 21R and 21L rotates forward and the other rotates rearward, the transport apparatus 1 exerts the thrust that laterally moves the bed 10, and simultaneously, a thrust that turns the bed 10.

In an example shown in a lower right part of FIG. 8, the transport apparatus 1 rotates the first mecanum wheel 21R rearward and rotates the second mecanum wheel 21L forward, generating a thrust that turns the bed 10 to the right. In this case, a turning path R of the bed 10 is in the shape of an arc having the above-described arrows A21 and A12 as tangents, and a rotation center Oz, which is the center position of the arc, is located at the rear end of the bed 10. Thus, the thrust applied to the bed 10 turns the portion of the bed 10 on the opposite side of the rotation center Oz (a front end portion of the bed 10) to the right.

When the first mecanum wheel 21R rotates rearward and the second mecanum wheel 21L rotates forward, both the thrust that turns the bed 10 to the right about the rotation center Oz located at the rear end of the bed 10 (i.e., a thrust that turns the front end of the bed 10 to the right) and the thrust that laterally moves the entire bed 10 to the right are applied to the bed 10. In this case, the front end of the bed 10 turns clockwise about the rotation center Oz. As a result, the front end of the bed 10 moves to the right more than the rear end.

Similarly, although not shown, when the first mecanum wheel 21R rotates forward and the second mecanum wheel 21L rotates rearward, both the thrust that turns the bed 10 to the left about the rotation center Oz located at the rear end of the bed 10 (i.e., a thrust that turns the front end of the bed 10 to the left) and the thrust that laterally moves the entire bed 10 to the left are applied to the bed 10. In this case, the front end of the bed 10 turns counterclockwise about the rotation center Oz. As a result, the front end of the bed 10 moves to the left more than the rear end.

The transport apparatus 1 according to the present embodiment actively takes the advantage of the above-described motion to achieve a smooth lateral movement of the bed using the two mecanum wheels, just like the devices having four mecanum wheels.

Specifically, when the left-right direction is inputted as the moving direction to the operation unit 3, the controller 4 according to the present embodiment operates the first and second mecanum wheels 21R and 21L via the first and second motors 22R and 22L to laterally move the bed 10 in the moving direction (the left or the right) inputted to the operation unit 3 while turning the bed 10 about the rotation center Oz located at the one end of the bed 10 (the rear end in the present embodiment).

In this case, the rear end of the bed 10 moves less in the inputted moving direction than the other end of the bed 10 (the front end in the present embodiment) because the rear end is closer to the rotation center Oz than the other end. However, the rear end of the bed 10 is supported by the operator 100. Thus, the operator 100 also moves laterally along with the lateral movement of the bed 10, ensuring the amount of movement of the rear end of the bed 10. This allows both the front end and the rear end of the bed 10 to move sufficiently, and causes the entire bed 10 to move laterally in the desired moving direction.

When the moving direction is inputted to the operation unit 3, the controller 4 according to the present embodiment commands the rotational speeds of the first and second mecanum wheels 21R and 21L so that one of the first and second mecanum wheels 21R and 21L rotates forward and the other rotates rearward, and when commanding the rotational speeds, makes the absolute values of the commanded rotational speeds of the first and second mecanum wheels 21R and 21L equal to each other.

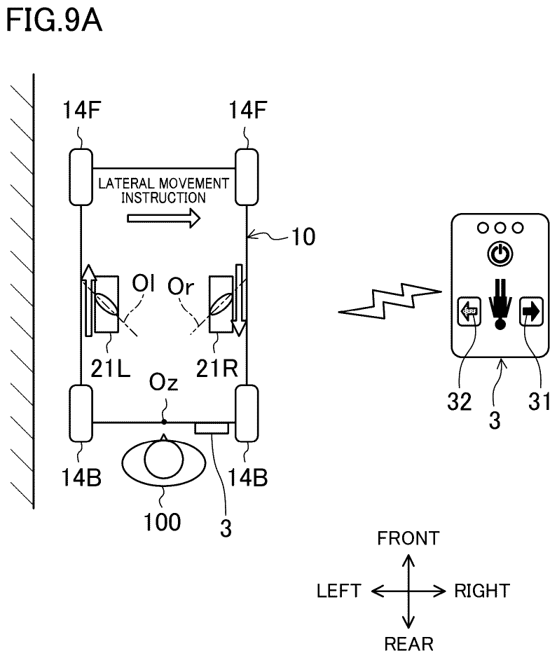

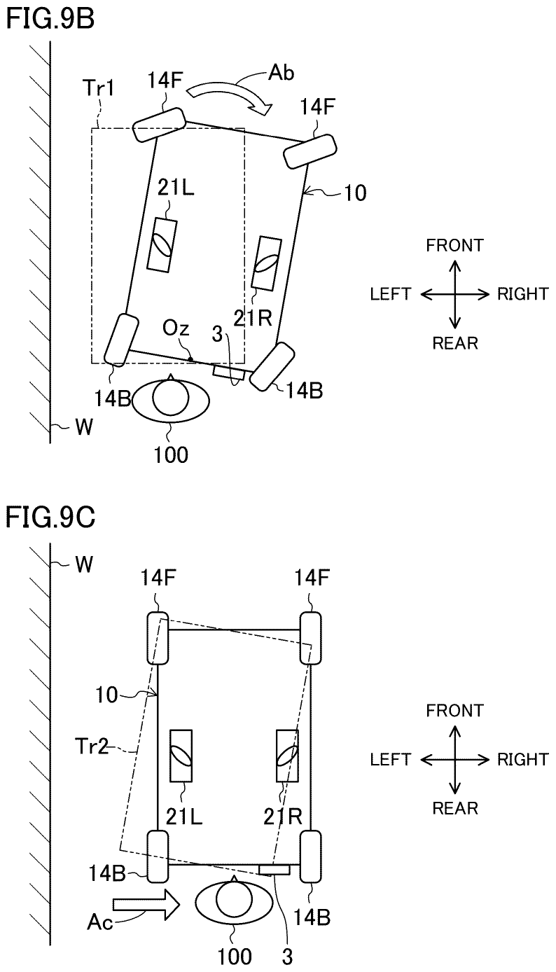

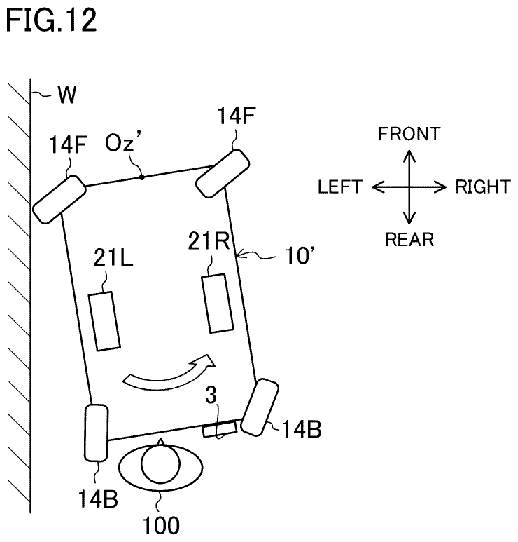

A specific example of the lateral movement of the bed 10 will be described with reference to FIGS. 9A, 9B, and 9C. FIGS. 9A, 9B, and 9C are views illustrating the specific example of the lateral movement using the transport apparatus 1. FIG. 12 is a view illustrating a conventional example of the transport apparatus.

First, in the example shown in FIG. 9A, a wall W is present on the left of the operator 100, and the bed 10 is laterally moved to the right from a position close to the wall W. In this case, a possible method is to apply a lateral force to the rear end of the bed 10 (e.g., the headboard 11h shown in FIG. 1) and detect the force to rotate the first and second mecanum wheels 21R and 21L (a so-called assist method).

However, when such a force is applied, the bed 10 may turn about a rotation center Oz′ which is located at the front end of the bed 10 or a center position between the first and second mecanum wheels 21R and 21L, and the front end of the bed 10 (the footboard 11f) may move toward the wall W (see FIG. 12). It is advantageous to avoid such a movement as much as possible to keep the bed 10 from hitting the wall W.

For this purpose, the first mecanum wheel 21R is rotated rearward and the second mecanum wheel 21L is rotated forward when the right switch 31 is pressed as shown in FIG. 9A. Thus, a thrust for turning the bed 10 to the right about the rotation center Oz which is located at the rear end of the bed 10 and a thrust for laterally moving the entire bed 10 to the right are both applied to the bed 10.

The two thrusts applied to the bed 10 move the whole part of the bed 10 from the rear end to the front end to the right, and turn the front end to the right as shown in FIG. 9B (see an arrow Ab in FIG. 9B). The amount of movement at this time is indicated by the deviation from the initial position Tr1 of the bed drawn with a two-dot-dash line. The initial position Tr1 is a schematic indication of the position of the bed 10 shown in FIG. 9A.

As shown in FIG. 9C, the operator 100 also moves to the right along with the movement and turning motion of the bed 10 to the right, and thus, the amount of rightward movement of the rear end supported by the operator 100 is ensured (see an arrow Ac in FIG. 9C). The amount of movement of the front end of the bed 10 is ensured by the turning motion, and the amount of movement of the rear end of the bed 10 is ensured by the movement of the operator 100, allowing the lateral movement of the entire bed 10 to the right. The amount of movement at this time is indicated by the deviation from a halfway position Tr2 of the bed drawn with a two-dot-dash line. The halfway position Tr2 is a schematic indication of the position of the bed 10 shown in FIG. 9B.

In a comparative example as a provisional configuration shown in FIG. 12, the bed 10 is turned about a rotation center Oz′ located at the front end of the bed 10. In this case, although the rear end supported by the operator 100 greatly moves in the lateral direction, the front end of the bed 10 needs to be turned by a lateral force applied by the operator 100. The front end of the bed 10 is farther from the operator 100 than the rear end, and requires a relatively large load to make such a movement. This is disadvantageous in achieving a smooth lateral movement.

When such a provisional configuration is adopted, the front end of the bed 10, or a portion near the rotation center Oz′ (the front left caster 14F in the example shown in FIG. 12), turns in the opposite direction, and the portion may hit the wall W.

Thus, setting the rotation center Oz at the rear end of the bed 10 as shown in FIGS. 9A to 9C is effective in reducing the load on the operator 100 and keeping the bed 10 from hitting the wall W.

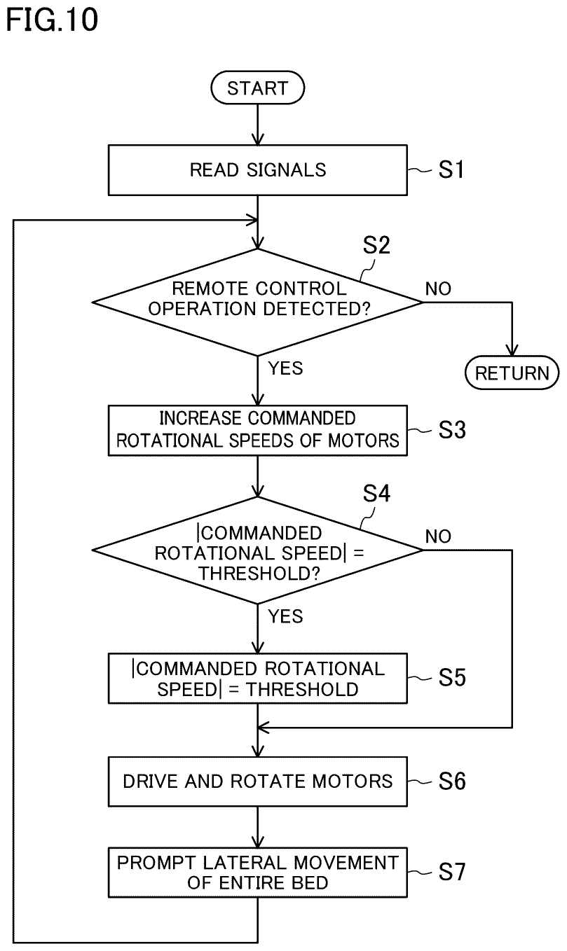

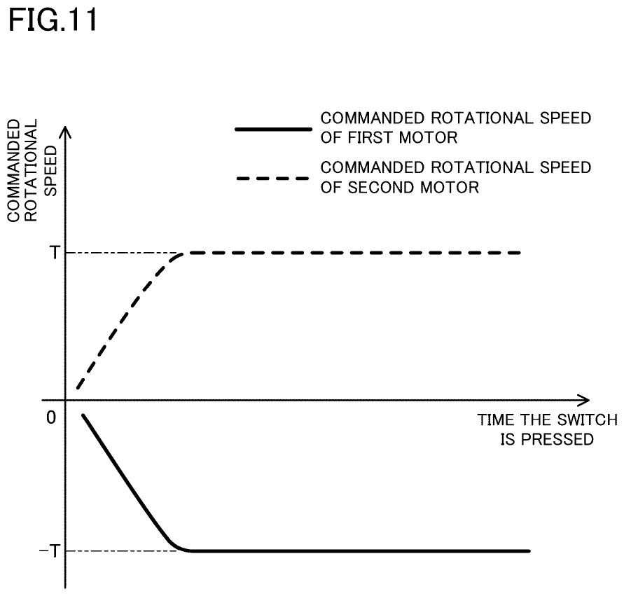

Next, a specific example of a process performed by the controller 4 for the lateral movement will be described below. FIG. 10 is a flowchart illustrating a process related to the lateral movement of the bed 10, and FIG. 11 is a graph of commanded rotational speeds of the motors during the lateral movement (particularly to the right).

First, in Step S1 of FIG. 10, the controller 4 reads an electrical signal outputted from the operation unit 3 (read signals). In the subsequent Step S2, the controller 4 determines whether an input to the operation unit 3 is detected based on whether the electric signal is read in Step S1 (remote control operation detected?).

If the answer is NO in Step S2, the control process returns. If the answer is YES in Step S2, the control process proceeds to Step S3.

In Step S3, the controller 4 increases the commanded rotational speeds of the first and second motors 22R and 22L. Each of the commanded rotational speeds increases with time the right switch 31 or the left switch 32 is pressed. At this time, the absolute value of the commanded rotational speed of the first motor 22R is set equal to the absolute value of the commanded rotational speed of the second motor 22L. The commanded rotational speed of the first motor 22R is equal to the commanded rotational speed of the first mecanum wheel 21R. The commanded rotational speed of the second motor 22L is equal to the commanded rotational speed of the second mecanum wheel 21L.

When the right switch 31 is pressed with the first inclined axis Or and the second inclined axis Ol set as in the present embodiment, the commanded rotational speed of the first motor 22R is negative, and the commanded rotational speed of the second motor 22L is positive. When the left switch 32 is pressed, the commanded rotational speed of the first motor 22R is positive, and the commanded rotational speed of the second motor 22L is negative.

In the present embodiment, the commanded rotational speed set to rotate the first or second mecanum wheel 21R or 21L forward is defined as “positive,” and the commanded rotational speed set to rotate the first or second mecanum wheel 21R or 21L rearward is defined as “negative.” In the subsequent Step S4, the controller 4 determines whether the commanded rotational speeds of the first and second motors 22R and 22L have reached predetermined thresholds T. The thresholds T are parameters set in advance, and are read from the memory of the controller 4 as appropriate. If the answer is NO, the control process skips Step S5 and proceeds to Step S6. If the answer is YES in Step S4, the control process proceeds to Step S6 via Step S5.

In Step S5, the controller 4 sets the commanded rotational speeds of the first and second motors 22R and 22L to the thresholds T. When the controller 4 performs the process of Step S5, the commanded rotational speeds of the first and second motors 22R and 22L are limited to values equal to or less than the thresholds T (see also FIG. 11). The signs of the commanded rotational speeds shown in FIG. 11 are merely examples for laterally moving the bed to the right. When moving the bed laterally to the left, the positive and negative signs of the commanded rotational speeds of the first and second motors 22R and 22L are reversed with respect to the values shown in FIG. 11.

In Step S6, the controller 4 drives the first and second motors 22R and 22L at the commanded rotational speeds set in Steps S4 and S5. This drive allows the operation described with reference to FIGS. 9A and 9B. Thus, the operator 100 is prompted to laterally move in the subsequent Step S7. When the operator 100 laterally moves, the entire bed 10 laterally moves in a desired direction as described with reference to FIG. 9C.

As described with reference to FIGS. 9A to 9C, according to the present embodiment, both the rear end of the bed 10 at which the rotation center Oz is located and the front end of the bed 10 opposite to the rotation center Oz can be laterally moved by making use of the motion unique to the use of the two mecanum wheels. Thus, with the transport apparatus using the two mecanum wheels, a smooth lateral movement of the bed can be achieved in the same manner as the device with four mecanum wheels.

As shown in FIGS. 1, 2, and 9A to 9C, the operation unit 3 is supported on the rear end of the bed 10. Thus, the operator 100 unconsciously supports the rear end of the bed 10 when operating the operation unit 3 without thinking of the rear end of the bed 10. This ensures the amount of movement of the rear end, as in the case where the operator 100 consciously supports the rear end. As a result, the rear end and the front end of the bed 10 sufficiently move, allowing the entire bed 10 to laterally move in a desired moving direction. This can achieve a smooth lateral movement of the bed although the transport apparatus 1 uses two mecanum wheels.

As described with reference to FIGS. 8 and 10, the first mecanum wheel 21R and the second mecanum wheel 21L are rotated in opposite directions to simultaneously generate a thrust for turning the bed 10 and a thrust for laterally moving the bed 10. The former thrust contributes to the generation of the turning motion about the rotation center Oz located at the rear end of the bed 10, and the latter thrust suitably acts to prompt the operator to move laterally. Thus, the configuration of the third aspect is effective in achieving a smooth lateral movement using the two mecanum wheels.

Further, as described with reference to FIG. 10, a lateral movement parallel to the lateral direction can be achieved by making the absolute values of the commanded rotational speeds of the first mecanum wheel 21R and the second mecanum wheel 21L equal to each other. This is effective in achieving a smooth lateral movement using the two mecanum wheels.

Further, for the conveyance of a medical bed, for example, the headboard 11h is usually supported by the operator 100. Thus, arranging the headboard 11h at the rear end where the rotation center Oz is located during the turning motion allows the operator 100 to naturally support the rear end without providing any special markers or indications. This is effective in achieving a smooth lateral movement using the two mecanum wheels.

### Other Embodiments

In the embodiment described above, the “one end” which the operator 100 supports and at which the rotation center Oz is located during the turning motion is defined as the rear end of the bed 10, the “other end” opposite to the one end in the front-rear direction is defined as the front end of the bed 10, and the operation unit 3 is arranged at the rear end, but the present disclosure is not limited to this configuration.

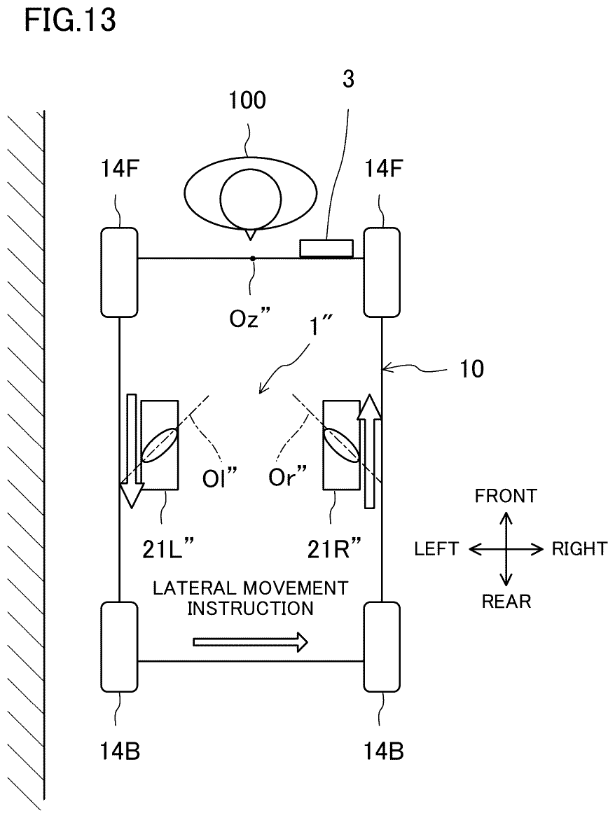

FIG. 13 is a view illustrating a variation of the transport apparatus 1. As in a transport apparatus 1″ according to the variation, the “one end” may be the front end of the bed 10, and the “other end” may be the rear end of the bed 10. In this case, the part of the bed supported by the operator 100 and the part of the bed where the operation unit 3 is attached are reversed in the front-rear direction, and a rotation center Oz″ is located at the front end of the bed 10. In this case, a first inclined axis Or″ of a first mecanum wheels 21R″ according to the variation and a second inclined axis Ol″ of a second mecanum wheel 21L″ according to the variation may be inclined from the inside to the outside in the left-right direction as they extend from the front end toward the rear end of the bed 10.

### DESCRIPTION OF REFERENCE CHARACTERS

1 Transport Apparatus
3 Operation Unit
4 Controller
10 Bed
11 Bed Body
11h Head Plate
11f Foot Plate
14 Caster
14F Front Caster
14B Rear Caster
21R First Mecanum Wheel
21L Second Mecanum Wheel
21a Wheel Body
21b Barrel-Shaped Roller
22R First Motor
22L Second Motor
Oz Rotation Center
Or First Inclined Axis
Ol Second Inclined Axis

1. A transport apparatus that is attached to a bed with casters and is configured to move the bed laterally, one end of the bed in a lengthwise direction being supported by an operator, the transport apparatus comprising:
a first mecanum wheel and a second mecanum wheel that are attached to a lower portion of the bed;
a first motor and a second motor that are respectively connected to the first mecanum wheel and the second mecanum wheel to drive the first mecanum wheel and the second mecanum wheel;
an operation unit that receives an input of a moving direction of the bed; and
a controller that controls the first and second motors,
wherein
when a lateral moving direction is inputted to the operation unit, the controller operates the first and second mecanum wheels via the first and second motors to move the bed in the lateral moving direction inputted to the operation unit while turning the bed about a rotation center located at the one end.

2. A transport apparatus that is attached to a bed with casters and is configured to move the bed laterally, the transport apparatus comprising:
a first mecanum wheel and a second mecanum wheel that are attached to a lower portion of the bed;
a first motor and a second motor that are respectively connected to the first mecanum wheel and the second mecanum wheel to drive the first mecanum wheel and the second mecanum wheel;
an operation unit that is configured to be supported on one end of the bed in a lengthwise direction and receives an input of a moving direction of the bed; and
a controller that controls the first and second motors,
wherein
when the moving direction is inputted to the operation unit, the controller operates the first and second mecanum wheels via the first and second motors to laterally move the bed in the moving direction inputted to the operation unit while turning the bed about a rotation center located at the one end.

3. The transport apparatus of claim 1, wherein
the first and second mecanum wheels are arranged side by side in a widthwise direction of the bed,
each of the first and second mecanum wheels includes
a wheel body that rotates about a rotation axis extending in the widthwise direction and
a plurality of barrel-shaped rollers arranged along an outer periphery of the wheel body and rotating about an inclined axis inclined with respect to both the widthwise direction and the lengthwise direction, and
the inclined axis of the first mecanum wheel is inclined with respect to the inclined axis of the second mecanum wheel to be line-symmetrical with respect to the lengthwise direction.

4. The transport apparatus of claim 3, wherein
when the moving direction is inputted to the operation unit, the controller commands rotational speeds of the first and second mecanum wheels so that one of the first and second mecanum wheels rotates forward and the other rotates rearward, and when commanding the rotational speeds, makes absolute values of the commanded rotational speeds of the first and second mecanum wheels equal to each other.

5. The transport apparatus of claim 1, wherein
a head plate of the bed is arranged at the one end, and
a foot plate of the bed is arranged at the other end opposite to the one end in the lengthwise direction.
